(19) United States
(12) Patent Application Publication
(10) Pub. No.: US 2023/0167869 A1
(43) Pub. Date: Jun. 1, 2023

(54) Support ring for a jounce bumper of a suspension system, jounce bumper assembly and use thereof

(71) Applicant: BASF Polyurethanes GmbH, Lemfoerde (DE)

(72) Inventor: Axel Pohlmann, Lemfoerde (DE)

(73) Assignee: BASF Polyurethanes GmbH, Lemfoerde (DE)

(21) Appl. No.: 17/756,718

(22) PCT Filed: Dec. 3, 2020
(86) PCT No.: PCT/EP2020/084536

§ 371 Date: Jun. 1, 2022

(30) Foreign Application Priority Data
Dec. 3, 2019 (EP) 19213066.4

(51) Int. Cl. F16F 1/371; B60G 11/22; F16F 1/373

(52) U.S. Cl. CPC F16F 1/3713; B60G 11/22; F16F 1/3732; F16F 9/58; F16F 2224/025; F16F 2226/04; F16F 2228/007

(57) ABSTRACT

A support ring for a resiliently deformable jounce bumper is made of a cast material. The support ring contains an inner circumferential surface that defines a through-opening extending along a longitudinal axis, an outer circumferential surface, a first axial end face, an opposing second axial end face, and a plurality of recesses configured to reduce the material mass which the support ring is made of. The through-opening is configured to fit around the jounce bumper. The plurality of recesses may be formed in at least one of the two end faces such that the recesses extend from the respective end face in the axial direction into the material of the support ring.

The present invention relates to a support ring for a resiliently deformable jounce bumper of a suspension system, preferably a vehicle suspension system such as a vehicle shock absorber, wherein the support ring is made of a cast material and comprises a first axial end face and a second axial end face facing away from the first end face and spaced apart from the first end face in the direction of the longitudinal axis, and a plurality of recesses configured to reduce the material mass which the support ring is made of.

Support rings of the aforementioned type are generally known in the industry, in particular in the automotive industry. Jounce bumpers are commonly used as additional spring elements that are mounted to the rods of vehicle shock absorbers. Jounce bumpers are intended to absorb kinetic energy when the vehicle suspension system, typically the shock absorber, is subjected to large forces, and the suspension travel approaches the maximum available travel.

Jounce bumpers thus are used to limit or prevent damage to the vehicle (or shock absorber) under excessive loads in the direction of the longitudinal axis.

These jounce bumpers have to meet to distinct criteria that are difficult to combine: On the one hand side, it is desired that the jounce bumper reacts very softly to initial deformation in order to cause little distraction to the suspension dynamics of the vehicle. On the other hand side, it is desired that the jounce bumper can withstand considerable forces and has a progressive spring behavior to withstand increasing loads and increasing deformation in the direction of the longitudinal axis.

In order to meet these criteria, conventional jounce bumpers have in the past inter alia been equipped with support rings that are placed on the outer periphery of the support ring, often in a correspondingly shaped groove on the jounce bumper. Since the support rings are stiff in the radial direction (at least when compared to the resiliently deformable jounce bumper), they progressively stiffen the jounce bumper the higher its deformation becomes.

Support rings are mass-produced, which is why it is desirable to produce these support rings from cast material by inserting moldable material into a die or mold and curing the material to assume the desired shape of the support ring. A common problem found with casting in general is that when certain amounts of material are cured, small cavities, also referred to as vacuoles, may form inside the curing structure. Since these vacuoles or cavities are detrimental to the mechanical integrity of the part, it is desired to limit or prevent as far as possible the creation of these vacuoles. With support rings, a common way of addressing this has been to reduce the material thickness of the support ring by introducing recesses into the support ring material. In prior art procedures, these recesses have been produced on the outer circumference of the support ring by providing corresponding circumferential protrusions in the die/mold. During so however makes it necessary to provide complicated geometries on the die/mold, and it also makes it complicated to remove the support ring from the die/mold after curing.

It has been attempted to mitigate this problem by providing a die/mold with radially moveable protruding features that can be protruded for the casting procedure and can then be retracted after curing to facilitate removal of the part from the tool.

While this procedure produces satisfactory support rings in terms of their build quality, the tool complexity and handling challenges involved are considered to be a disadvantage.

US 2013/187320 A1 relates to damper bearings comprising a hollow housing for accommodating a damping element and also a cover for fixing the damping element in the housing, the inner surface of the cover or both inner surfaces have contouring formed by elevations and depressions.

From DE 202 18 893 U1, a spring design is known which suggests a hollow cylindrical damping element. The damping element comprises an edge, and a hollow mounting socket is attached to the edge.

DE 101 57 325 A1 relates to spring elements comprising a support ring wherein the support ring has a reinforcement embedded in a thermoplastic coating.

In light thereof, it was an object of the invention to provide a support ring of the aforementioned type which is easier to manufacture without sacrificing the stability and longevity of the support ring and jounce bumper assemblies carrying such a support ring.

The invention attains this object by suggesting a jounce bumper wherein the plurality of recesses is formed in at least one of the two and end faces such that the recesses extend from the respective end face in the direction of the longitudinal axis into the material of the support ring. By forming the recesses in the axial end faces instead of the outer circumferential surface of the support ring, the complexity of the casting die/mold can be significantly reduced. It is no longer necessary to provide retractable features to allow for demolding after curing. At the same time, the material thickness reduction is achieved and creation of vacuoles is mitigated just as well as before, if not better.

The invention is also based upon the realization that a technical prejudice held in the industry prior to the invention has been overcome:

Prior to the invention, it was considered detrimental to the long-term stability of the jounce bumper assembly if the axial end faces of the support ring had recessed or protruding feature on them. During operation of a vehicle suspension system, for example, the jounce bumper is repeatedly compressed in the direction of the longitudinal axis. When this occurs, the resiliently deformable material of the jounce bumper is pushed against the support ring, and in particular also against the axial end faces. Protruding and recessed features, so it was feared, would cause stress peaks and friction between the support ring end faces and the resiliently deformable material of the jounce bumper, leading to material fatigue and possibly leading to premature failure of the jounce bumper part after a predetermined amount of load cycles.

It turns out, however, that it is possible to provide recesses in the axial end faces without sacrificing the longevity of a jounce bumper assembly after all.

According to the invention, the first end face comprises a first plurality of recesses, and the second end face comprises a second plurality of recesses, both extending from the respective end face into the material of the support ring.

In a preferred embodiment, all recesses within the respective plurality of recesses are equidistantly angularly spaced from one another. This contributes to a uniform distribution of forces throughout the support ring material and jounce bumper when assembled to a jounce bumper assembly.

According to the invention, the recesses of the second plurality of recesses are rotationally shifted about the longitudinal axis of the support ring relative to the first plurality of recesses. In other words, the recesses of the second plurality are not oriented to be coaxial with recesses of the first plurality of recesses, but rotationally/angularly displaced relative to the opposing recesses of the first plurality. This helps to ensure that the material thickness of the support ring is not reduced too severely in sections where oppositely located recesses are located close to one another.

Preferably, the rotational shifts of the second recesses amount to half the distance of two adjacent oppositely positioned recesses of the first plurality of recesses. In other words, one respective recess of the second plurality of recesses is positioned halfway between two recesses of the first plurality of recesses on the opposite end face.

In a further preferred embodiment, the first and second plurality of recesses comprise an identical number of recesses. An another preferred embodiment, the number of recesses per end face is in the range of 8 or higher, preferably in the range of 12 or higher, further preferably in the range of 18 or higher and particularly preferred in a range of 20 - 32. This embodiment also makes it easy to maintain a desired material strength in between adjacent recesses.

Preferentially, within a plurality, all recesses are arranged on a common diameter D_{R}.

In a further preferred embodiment, the diameter D_{R} is in a range of (0.8 Do + Di) / 2 to (1.2 Do + Dₗ) / 2, wherein Do is the outer diameter of the support ring and Dₗ is the inner diameter of the support ring.

In general terms, the support ring has an inner circumferential surface that defines a through-opening extending along the longitudinal axis, said through-opening being configured to mount the support ring to the jounce bumper, an outer circumferential surface, wherein the radial distance between the inner and outer circumferential surface defines a radial thickness of the support ring between the outer diameter and the inner diameter. Likewise, the distance in the axial direction between the two axial end faces defines an axial thickness of the support ring.

In a further preferred embodiment, the recesses have a clear opening in the radial direction, said clear opening preferably being in the range of 0.15 t_{R} to 0.45 t_{R} with t_{R} being the material thickness of the support ring in the radial direction.

It has been observed within the realisation of the invention that a higher number of recesses per plurality combined with a rather smaller clear opening of each recess produces better longevity of the jounce bumper assembly as compared to a low number of recesses with very large individual clear openings of each recess.

In embodiments where the recesses have a circular cross section in the direction of the longitudinal axis, i.e. the axis into which they extend into the material, the clear opening is the opening diameter of the recess. In embodiments where the recesses are non-circular, the clear opening is defined as the clearance in the radial direction.

In a further preferred embodiment, the recesses open into the respective end face with a rounded edge. The rounded edge helps to reduce stress peaks in the jounce bumper material when compressed against the support ring and also inside the support ring itself for improved force distribution.

In a further preferred embodiment, the cast material is a compact material, in particular selected from:
a compact elastomer, in particular rubber, preferably a blend of butadiene and polyisoprene rubber (BR/IR), or ethylene-propylene rubber (EPDM), particularly preferred having a shore A hardness of 45 or higher, further preferably 70 or higher,
a thermoplastic polymer, preferably polyoxymethylene (POM), a polyamide-based polymer or polyamide (PA), particularly preferred PA6, PA6.6. or a polyketone (PK),
a metal, in particular aluminium, an aluminium alloy, steel or a steel alloy, or
a combination of several or all of the above.

The invention has hereinabove been described with respect to a support ring in a first aspect.

In a second aspect, the invention also relates to a jounce bumper assembly for a suspension system, preferably for a vehicle suspension system, I particular for a vehicle shock absorber, the assembly comprising a jounce bumper comprising a first end portion, a second end portion, a longitudinal axis extending from the first end portion to the second end portion, wherein the jounce bumper is configured to resiliently deform between an uncompressed state and a compressed state, wherein in the compressed state, the jounce bumper has a smaller length in the direction of the longitudinal axis than in the uncompressed state and comprises an outer circumferential groove disposed between and spaced apart from the first and second end portion, and a support ring that is mounted in the outer circumferential groove.

The invention in this second aspect meets the initially described objective by suggesting that the support ring is formed according to any one of the preferred embodiments described herein above.

The preferred embodiments and advantages of the support ring of the first aspect are at the same time also preferred embodiments and advantages of the jounce bumper assembly of the second aspect.

Preferably, the jounce bumper is partially or completely made of a volume-compressible material, wherein preferably, the volume-compressible material is a cellular polyisocyanate polyaddition product.

Preferably, the volume-compressible material is a cellular polyisocyanate polyaddition product.

The jounce bumper can be composed of an elastomer, but it can also be composed of a plurality of elastomers which are present in layers, in shell form or in another form or also in a mixture with one another. The polyisocyanate polyaddition products are preferably constructed on the basis of microcellular polyurethane elastomers, on the basis of thermoplastic polyurethane or from combinations of said two materials which may optionally comprise polyurea structures.

Microcellular polyurethane elastomers which, in a preferred embodiment, have a density according to DIN 53420 of 200 kg/m3 to 1100 kg/m3, preferably 300 kg/m3 to 800 kg/m3, a tensile strength according to DIN 53571 of 2 N/mm2, preferably 2 N/mm2 to 8 N/mm2, an elongation according to DIN 53571 of 300%, preferably 300% to 700%, and a tear strength according to DIN 53515 of preferably 8 N/mm to 25 N/mm are particularly preferred.

The elastomers are preferably microcellular elastomers on the basis of polyisocyanate polyaddition products, preferably having cells with a diameter of 0.01 mm to 0.5 mm, particularly preferably 0.01 to 0.15 mm.

Elastomers on the basis of polyisocyanate polyaddition products and the production thereof are known in general and described numerously, for example in EP A 62 835, EP A 36 994, EP A 250 969, DE A 195 48 770 and DE A 195 48 771.

Production customarily takes place by reacting isocyanates with compounds which are reactive to isocyanates.

The elastomers on the basis of cellular polyisocyanate polyaddition products are customarily produced in a mold in which the reactive starting components are reacted with one another. Suitable molds here are generally customary molds, for example metal molds, which, on the basis of their shape, ensure the three dimensional shape according to the invention of the spring element. In one embodiment, the contour elements are integrated directly in the casting mold; in a further embodiment, they are retrospectively incorporated into the basic body. In a preferred embodiment, the spring element is cooled for this purpose until it solidifies, preferably with liquid nitrogen, and processed in this state.

The polyisocyanate polyaddition products can be produced according to generally known methods, for example by the following starting substances being used in a single or two stage process:
(a) isocyanate,
(b) compounds reactive to isocyanates,
(c) water and optionally
(d) catalysts,
(e) blowing agents and/or
(f) auxiliary and/or additional substances, for example polysiloxanes and/or fatty acid sulfonates.

The surface temperature of the inner wall of the mold is customarily 40° C. to 95° C., preferably 50° C. to 90° C. The production of the molded parts is advantageously carried out at an NCO/OH ratio of 0.85 to 1.20, wherein the heated starting components are mixed and brought in a quantity corresponding to the desired molded part density into a heated, preferably tightly closing molding tool. The molded parts are cured for 5 minutes to 60 minutes and then can be removed from the mold. The quantity of the reaction mixture introduced into the molding tool is customarily dimensioned in such a manner that the molded bodies obtained have the density already presented. The starting components are customarily introduced into the molding tool at a temperature of 15° C. to 120° C., preferably of 30° C. to 110° C. The degrees of compression for producing the molded bodies lie between 1.1 and 8, preferably between 2 and 6. The cellular polyisocyanate polyaddition products are expediently produced according to the “one shot” method with the aid of high pressure technology, low pressure technology or in particular reaction injection molding technology (RIM) in open or preferably closed molding tools. The reaction is carried out in particular by compression in a closed molding tool. The reaction injection molding technology is described, for example, by H. Piechota and H. Röhr in “Integralschaumstoffe”, Carl Hanser-Verlag, Munich, Vienna 1975; D.J. Prepelka and J.L. Wharton in Journal of Cellular Plastics, March/April 1975, pages 87 to 98 and U. Knipp in Journal of Cellular Plastics, March/April 1973, pages 76-84.

Alternatively, the jounce bumper is partially or completely made of rubber.

In a further aspect, the invention relates to the use of a support ring in a jounce bumper assembly. The invention suggests that the support ring according to any one of the preferred embodiments described herein above is used in a jounce bumper assembly, wherein the jounce comprises a first end portion, a second end portion, a longitudinal axis extending from the first end portion to the second end portion, wherein the jounce bumper is configured to resiliently deform between an uncompressed state and a compressed, wherein in the compresses state, the jounce bumper has a smaller length in the direction of the longitudinal axis than in the uncompressed state, and comprises an outer circumferential grove disposed between and spaced apart from the first and second end portion, and a support ring that is mounted in the outer circumferential groove.

Again, the advantages and preferred embodiments of the support ring described above in the first aspect and the jounce bumper assembly described above in the second aspect are at the same time preferred embodiments and advantages of the use. To avoid unnecessary repetition, reference is made to the descriptions herein above.

The invention will hereinafter be described in more detail with respect to a preferred embodiment with reference to the accompanying figures, wherein:

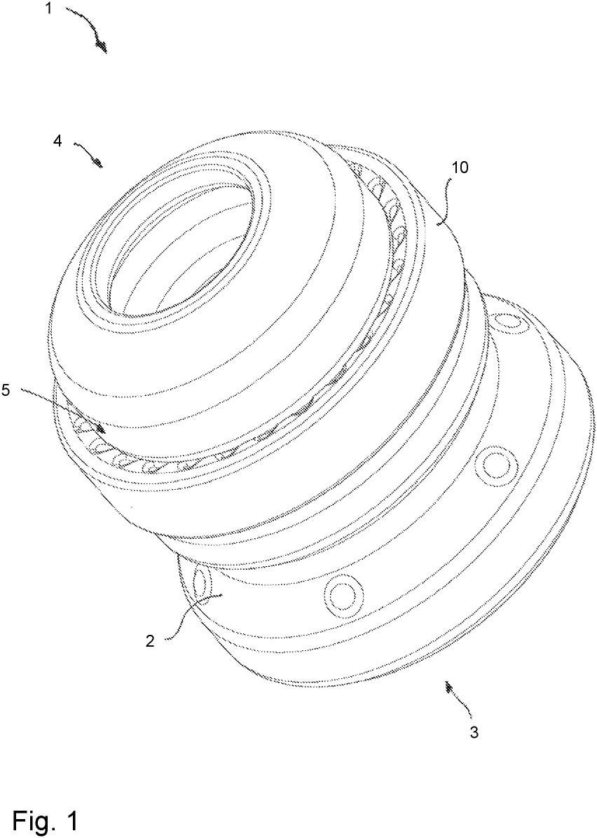

FIG. 1 shows a schematic three-dimensional view of a jounce bumper assembly according to a preferred embodiment having a support ring according to a preferred embodiment,

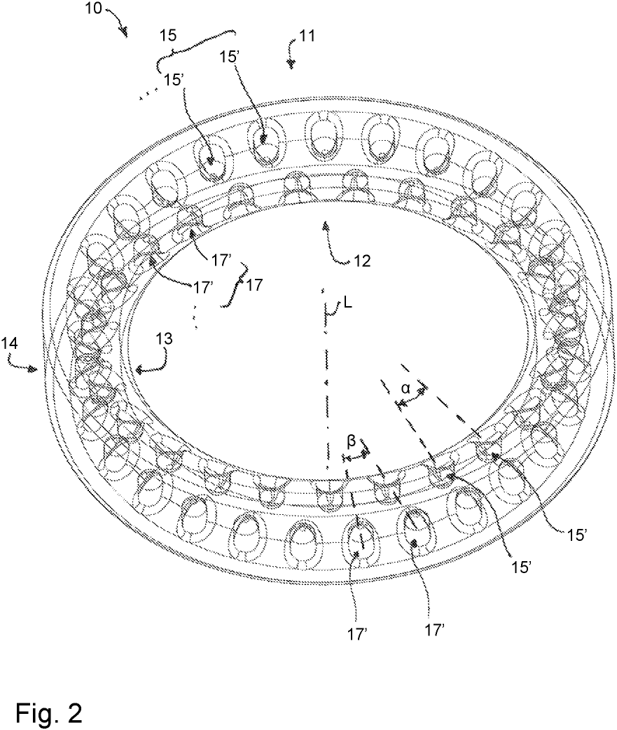

FIG. 2 shows the support ring of FIG. 1 in a schematic three-dimensional wire frame view, and

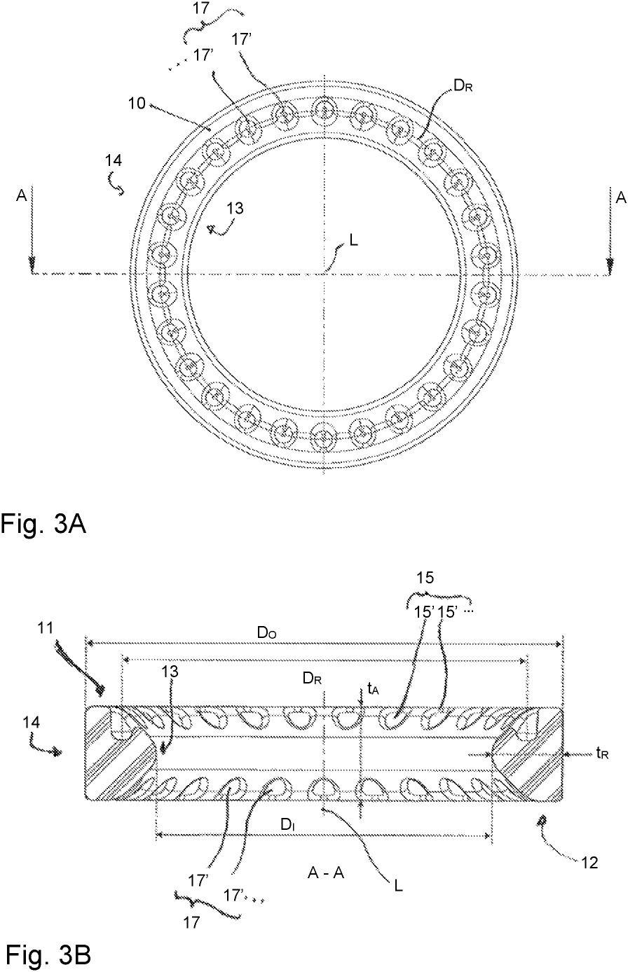

FIG. 3a, b show schematic side views of the support ring according to FIGS. 1 and 2.

FIG. 1 depicts a jounce bumper assembly 1 according to a preferred embodiment. The jounce bumper assembly 1 comprises a resiliently deformable jounce bumper 2. The jounce bumper 2 comprises a first end portion 3 and a second end portion 4. The first end portion 3 is configured to be mounted to e.g. and end cap of a shock absorber assembly for a vehicle suspension. The second end portion 4, also referred to as tip portion, is configured to be broad into contact with the opposing damper cap of the shock absorber housing (not shown). The jounce bumper comprises a central opening for accommodating the main rod of a shock absorber.

Spaced apart from both end portions 3, 4 and disposed therebetween, the jounce bumper assembly 1 comprises a support ring 10 which is mounted inside a circumferential groove 5 provided on the jounce bumper 2. Details of the support ring 10 are shown in FIGS. 2 and 3a, b.

As can be seen from FIGS. 1 - 3b, the support ring 10 comprises a contour-free outer circumferential surface 14 and an oppositely located (contour-free) inner circumferential surface 13.

In the direction of the longitudinal axis L, the support ring 10 comprises a first axial end face 11 and an oppositely located second end face 12 facing away from the first end face 11.

A first plurality 15 of recesses 15′ is arranged on the first end face 11 such that the recesses 15′ within that first plurality 15 extend substantially parallel to the longitudinal axis L into the material of the support ring 10.

The material of the support ring 10 preferably is as described hereinabove in the general portion of this document.

The recesses 15′ are equidistantly angularly spaced by an angle α and equally distributed about the circumference of the first axial end face 11.

In this preferred embodiment, the second axial end face 12 also comprises a plurality 17 of recesses 17′ which extend into the material of the support ring 10. Preferably, the recesses 17′ are oriented parallel to the longitudinal axis L.

Further preferably, the recesses 17′ of the second plurality 17 are equidistantly spaced from one another by an angle β and also preferably equally distributed among the circumference of the second end face 12.

In the embodiment shown in FIG. 2, the recesses 15′ of the first plurality 15 and the recesses 17′ of the second plurality 17 are not oriented flush to one another, but instead are rotationally offset such that each second recess 17′ extends into the spacing left between two adjacent recesses 15′ of the first plurality 15. Preferably, the angles α und 13 are equal, for example in a range between 8° and 18°. The angular offset between the first recesses 15′ and the second recesses 17′ preferably is 0.5 α in or. 0.5 β.

It shall be noted that while the preferred embodiment shows that the recesses 15′, 17′ are oriented parallel to the longitudinal axis L, the recesses could also be oriented at an inclination relative to the longitudinal axis without adverse effect on the longevity of the jounce bumper assembly 1. The parallel orientation is however beneficial for demolding the support ring after casting.

As can be seen from FIGS. 3a, b, the recesses 15′, 17′ do not extend completely through the axial thickness t_{R} of the support ring (10) but instead have a depth in direction of the longitudinal axis L < 0.5 t_{R}. Due to the angular offset between the first and second recesses 15′, 17′, the depths of the recesses could however be increased beyond what is shown in FIG. 3b.

The recesses 15′, 17′ are in the shown embodiment placed on one common diameter D_{R}. D_{R} is preferably selected to lie in between the outer diameter Do and the inner diameter Dₗ. In the embodiment shown in FIG. 3b, D_{R} is at (Do + Di)/2. This leaves enough material thickness of the overall radial thickness t_{R} inside and outside of the support ring 10 to ensure mechanical stability. It is to be noted, however, that the first plurality 15 and second plurality 17 of recesses could be placed on distinct diameters, i.e. radially offset with respect to one another within the scope of the invention.

As is evident from FIGS. 1 to 3b, the support ring 10 and jounce bumper 1 of the preferred embodiment can be assembled in conventional manner, requiring no adaptation of handling from the user in the industry where the jounce bumper assembly and support ring are to be applied. As can be seen in particular from FIGS. 2 and 3a, b, the support ring 10 is very easy to manufacture by casting, requiring no particular complexities on the side of the die/mold during casting. The recesses provide satisfactory material reduction to mitigate the risk of vacuoles and are distributed such as to provide uniform load distribution inside of this support ring 10 and towards jounce bumper 2.

1-13. (canceled)

14. A support ring for a resiliently deformable jounce bumper of a suspension system, said support ring being configured to be placed on an outer periphery in a correspondingly shaped groove on the jounce bumper to stiffen the jounce bumper during deformation, the support ring comprising:
an inner circumferential surface that defines a through-opening extending along a longitudinal axis, said through-opening being configured to fit around the jounce bumper,
an outer circumferential surface,
a first axial end face and an opposing second axial end face, and
at least one plurality of recesses configured to reduce a material mass which the support ring is made of;
wherein the support ring is made of a cast material,
wherein the first axial end face comprises a first plurality of recesses of the at least one plurality of recesses, and the second axial end face comprises a second plurality of recesses of the at least one plurality of recesses, wherein both the first plurality of recesses and the second plurality of recesses extend from a respective end face in an axial direction into the cast material of the support ring, and
wherein recesses of the second plurality of recesses are rotationally shifted about the longitudinal axis of the support ring relative to the first plurality of recesses.

15. The support ring of claim 14, wherein within each of the first plurality of recesses and the second plurality of recesses, all recesses are equidistantly angularly spaced from one another.

16. The support ring of claim 14, wherein a rotational shift of the recesses of the second plurality of recesses amounts to half a distance of two adjacent oppositely positioned recesses of the first plurality of recesses.

17. The support ring of claim 14, wherein the first plurality of recesses and second plurality of recesses comprise an identical number of recesses.

18. The support ring of claim 14, wherein a number of recesses on each of the first axial end face and the second axial end face is 8 or higher.

19. The support ring of claim 14, wherein within each of the first plurality of recesses and the second plurality of recesses, all recesses are arranged on a common diameter D_{R}.

20. The support ring of claim 19, wherein said diameter D_{R} is in a range of (0.8 Do + Di)/2 to (1.2 Do +Di)/2, wherein Do is an outer diameter of the support ring and D_{I} is an inner diameter of the support ring.

21. The support ring of claim 14, wherein the first plurality of recesses and the second plurality of recesses have a clear opening in a radial direction.

22. The support ring of claim 14, wherein the first plurality of recesses and the second plurality of recesses open into the respective end face with a rounded edge.

23. The support ring of claim 14, wherein the cast material is a compact material.

24. A jounce bumper assembly for a suspension system, comprising:
a jounce bumper comprising a first end portion, a second end portion, a longitudinal axis extending from the first end portion to the second end portion, and an outer circumferential groove disposed between and spaced apart from the first end portion and the second end portion, wherein the jounce bumper is configured to resiliently deform between an uncompressed state and a compressed state, wherein in the compressed state, the jounce bumper has a smaller length in the direction of the longitudinal axis than in the uncompressed state, and
the support ring according to claim 14, arranged in the outer circumferential groove and abutting against the jounce bumper.

25. The jounce bumper assembly of claim 24, wherein the jounce bumper is partially or completely made of a volume-compressible material.

26. A method, comprising:
arranging the support ring according to claim 14 in an outer circumferential groove of a jounce bumper and abutting against the jounce bumper,
wherein the jounce bumper comprises a first end portion, a second end portion, a longitudinal axis extending from the first end portion to the second end portion, and the outer circumferential groove disposed between and spaced apart from the first end portion and the second end portion, wherein the jounce bumper is configured to resiliently deform between an uncompressed state and a compressed state, wherein in the compressed state, the jounce bumper has a smaller length in the direction of the longitudinal axis than in the uncompressed state.

27. The support ring of claim 14, wherein the suspension system is a vehicle suspension system.

28. The support ring of claim 18, wherein the number of recesses on each of the first axial end face and the second axial end face is in a range of 20 to 32.

29. The support ring of claim 21, wherein the clear opening has a diameter in the range of 0.15 t_{R} to 0.45 t_{R}, wherein t_{R} is a material thickness of the support ring in the radial direction.

30. The support ring of claim 23, wherein the compact material is at least one selected from the group consisting of a compact elastomer, a thermoplastic polymer, a metal, and a combination thereof.

31. The support ring of claim 23, wherein the compact material is at least one selected from the group consisting of a blend of butadiene and polyisoprene rubber (BR/IR), ethylene-propylene rubber (EPDM), polyoxymethylene (POM), a polyamide-based polymer, a polyamide (PA), a poly ketone (PK), aluminum, an aluminum alloy, steel, a steel alloy, and a combination thereof.

32. The support ring of claim 23, wherein the compact material is a compact elastomer having a shore A hardness of 45 or higher.

33. The jounce bumper assembly of claim 25, wherein the volume-compressible material is a cellular polyisocyanate polyaddition product.
